(19) United States
(12) Patent Application Publication
(10) Pub. No.: US 2012/0212098 A1
(43) Pub. Date: Aug. 23, 2012

(54) ELECTRIC MACHINE, HYDRAULICS UNIT

(75) Inventor: Alain-Bernard Isel, Riedseltz (FR)

(73) Assignee: ROBERT BOSCH GMBH, Stuttgart (DE)

(21) Appl. No.: 13/502,866

(22) PCT Filed: Aug. 20, 2010
(86) PCT No.: PCT/EP2010/062187

§ 371 Date: Apr. 19, 2012

(30) Foreign Application Priority Data
Oct. 19, 2009 (DE) 10 2009 045 797.6

(51) Int. Cl. H02K 1/06

(52) U.S. Cl. 310/261.1

(57) ABSTRACT

The invention relates to an electric machine (2), comprising at least one rotor shaft (3) that is rotatably mounted in a housing (4) by means of at least one rolling body bearing (5), wherein at least one commutator (14) is arranged in a rotationally 11 fixed manner on the rotor shaft (3). To this end, a centrifugal disc (16) is arranged in a rotationally fixed manner on the rotor shaft (3) on the side of the rolling body bearing (5) opposite of the commutator (14). The invention further relates to a hydraulics unit (1), in particular for a motor vehicle, comprising a housing (4) and an electric machine (2).

### BACKGROUND OF THE INVENTION

The invention relates to an electrical machine having at least one rotor shaft which is borne by means of at least one rolling-body bearing such that it can rotate in a housing, with at least one commutator being arranged on the rotor shaft such that they rotate together.

Furthermore, the invention relates to a hydraulic unit, in particular for a motor vehicle, which has a housing and an electrical machine.

Electrical machines and hydraulic units of the type addressed here are known from the prior art. Electrical machines which have a mechanically operating commutator and are intended to be used in applications in which liquid can enter the housing of the electrical machine have the disadvantage that the liquid can flow through the rolling-body bearing which bears and/or supports the rotor shaft, and can be forced/fed through it on the basis of capillary effects. In general, rolling-body bearings are provided with lubricant in order to minimize friction and possibly also for cooling. It is admittedly known for the sealing of such rolling-body bearings to be increased by means of appropriate sealing disks but a leakage gap cannot be avoided even here, since it must also be possible for the two rings of the rolling-body bearing to be furthermore rotated relative to one another. If the liquid passes through the rolling-body bearing once in the axial direction, then it carries lubricant with it, and carries this lubricant out of the rolling-body bearing. The rolling-body bearing is therefore, so to speak, washed out. In the case of electrical machines, this can lead to the lubricant which has been washed out of the rolling-body bearing being passed to the commutator and adversely affecting its operation. This process is also known by the expression pasting.

### SUMMARY OF THE INVENTION

The electrical machine according to the invention ensures a long life in a simple manner, by the prevention of pasting of the commutator. It is distinguished in that a centrifugal disk is arranged on the rotor shaft such that they rotate together, on the opposite side of the rolling-body bearing to the commutator. During operation, the centrifugal disk ensures that liquid which could pass through the rolling-body bearing in the direction of the commutator is thrown outward by the rotation of the rotor shaft, and therefore with the rotation of the centrifugal disk, that is to say, in the end, it is thrown away from critical areas of the rolling-body bearing. The centrifugal disk is for this purpose aligned at least essentially at right angles on or to the rotor shaft, and is preferably arranged close to the rolling-body bearing.

Expediently, the maximum diameter of the centrifugal disk is at least as large as the internal diameter of an outer ring of the rolling-body bearing. Seen radially, the centrifugal disk therefore extends from the internal diameter of the roller bearing inner ring at least as far as the internal diameter of the roller bearing outer ring, in such a way that the centrifugal disk covers at least that area of the rolling-body bearing which contains the lubricant. The closer the centrifugal disk is arranged to the rolling-body bearing in this case, the greater is the protective effect.

Furthermore, the invention provides that the centrifugal disk has an incline which extends over the entire circumference and at least in its outer circumferential area. This incline allows liquid to be thrown or fed deliberately away from the rolling-body bearing. For this purpose, the incline expediently faces away from the rolling-body bearing, thus reliably preventing the rolling-body bearing from being washed out, and in the end preventing pasting of the commutator.

Preferably, the incline is at an angle of 15° to 70°, in particular 25° to 60° to the centrifugal disk. This means that the circumferential area of the centrifugal disk which has the incline has at least one surface which is at an angle of 15° to 70°, in particular 25° to 60°, to the centrifugal disk, or imaginary centrifugal disk plane, which is otherwise aligned at least essentially at right angles to the rotor shaft. The incline may in this case have a straight or else a curved profile.

In one preferred refinement of the electrical machine, the circumferential area is bent in order to form the incline. The centrifugal disk is therefore bent on its outer circumferential area such that it forms the incline which extends over the entire circumference. In this case, the bent shape may be predetermined during the original forming of the centrifugal disk, or else only during a subsequent forming process. The choice for the production of the bent edge area in this case depends essentially on the material of the centrifugal disk. The formation of the incline of the bent edge area has the advantage that material costs and weight are saved.

Advantageously, the centrifugal disk has an annular corrugated profile, at least in places, with the annular corrugations of the corrugated profile expediently being located coaxially with respect to the rotation axis of the centrifugal disk and with respect to the rotor shaft, and therefore each extending over the circumference of the centrifugal disk. This provides the centrifugal disk with a certain amount of flexibility and liquid can be centrifuged in a plurality of radial areas since, in the end, the corrugated structure forms a plurality of inclines. In particular, the incline as described above in the outer circumferential area is also formed by the corrugated structure.

Furthermore, the invention provides that the maximum diameter of the centrifugal disk is less than the internal diameter of the housing in the area of the centrifugal disk. This ensures there is a radial air gap between the centrifugal disk and the housing of the electrical machine. Expediently, the air gap has a width of 0.5 to 3 mm, in particular of 1.0 to 2.0 mm. On the one hand, this provides the centrifugal disk with the capability to expand outward at high rotation speeds, as is ensured, for example, by the flexibility of the corrugated structure, without a friction contact being produced between the centrifugal disk and the housing.

The invention furthermore provides that, advantageously at least one eccentric bearing is arranged on the rotor shaft, on the side of the rolling-body bearing facing away from the commutator. In this case, the eccentric bearing is used in particular to compensate for mass forces of the rotor shaft. The centrifugal disk has a particularly advantageous effect here since the eccentricity of the eccentric bearing can lead to the liquid being displaced in the direction of the ball bearing.

In this case, expediently, the centrifugal disk is held or bored axially between the eccentric bearing and the rolling-body bearing. Particularly preferably the centrifugal disk is clamped in or held in a braced manner between the eccentric bearing and the rolling-body bearing. In this case, the prestressing can be achieved in a simple manner, in particular on the basis of the corrugated structure.

The hydraulic unit according to the invention is distinguished by an electrical machine as has been described above. In hydraulic units, in particular for braking systems in motor vehicles, for example in ABS devices (ABS=anti-lock braking system) or else ESP devices (ESP=electronic stability program), there are liquids in the immediate vicinity of the electrical machine and these are used, for example, to build up liquid pressure in a hydraulic circuit of the hydraulic unit. The advantageous design of the electrical machine with the centrifugal disk in this case allows long-term operation of the electrical machine by effectively preventing pasting of the commutator.

### BRIEF DESCRIPTION OF THE DRAWINGS

The invention will be explained in more detail in the following text with reference to the drawing, in which:

FIG. 1 shows a simplified section illustration of an electrical machine, and

FIG. 2 shows a perspective illustration of a centrifugal disk of the electrical machine.

### DETAILED DESCRIPTION

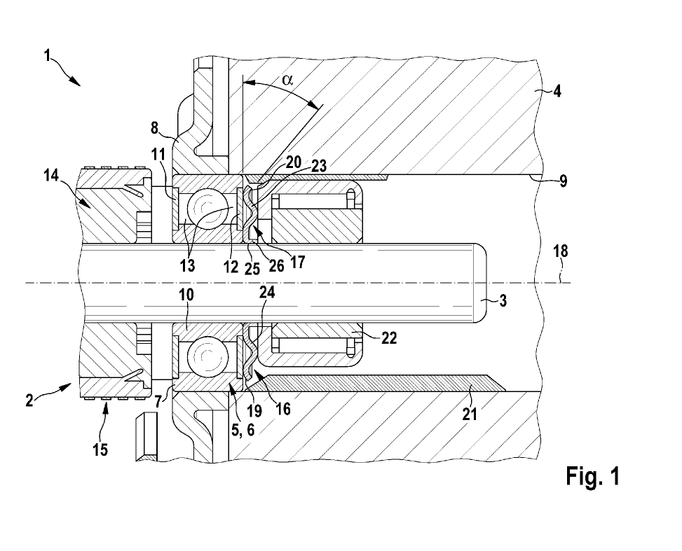

FIG. 1 shows a simplified section illustration of a detail of a hydraulic unit 1. The hydraulic unit 1 comprises an electrical machine 2, whose rotor shaft 3 is borne in a housing 4. The housing 4 is therefore a component of both the hydraulic unit 1 and of the electrical machine 2. A rolling-body bearing 5 is provided for bearing the rotor shaft 3, in this case in the form of a ball bearing 6. The rolling-body bearing 5 is essentially held radially on its outer ring 7 by a bearing cover 8, and projects in places into a receptacle 9 in the housing 4. The rolling-body bearing 5 furthermore has an inner ring 10, which is arranged on the rotor shaft 3 such that they rotate together. Rolling bodies, in this case in the form of balls, are guided in appropriate grooves between the outer ring 7 and the inner ring 10. On its axial end faces, the rolling-body bearing 5 is closed by means of sealing rings 11, 12, with the sealing rings 11, 12 respectively being attached to the outer ring 7 or to the inner ring 10 and only resting on the corresponding other ring 10, 7 of the rolling-body bearing 5, such that relative movement is possible between the outer ring 7 and the inner ring 10. The internal area 13 of the rolling-body bearing 5 is expendiently at least partially filled with a lubricant. In the simplest case, the lubricant is a lubricating grease.

In the illustration shown in FIG. 1, a commutator 14 is arranged, such that they rotate together, on the rotor shaft 3 of the electrical machine 2, to the left of the rolling-body bearing 5. On its outer envelope surface, the commutator 14 has commutator laminates 15, which interact with the commutator brushes, which are not illustrated here, of the electrical machine 2.

Furthermore, a centrifugal disk 16 is also arranged on the rotor shaft 3 such that they rotate together, to the right of the rolling-body bearing 5 in the illustration, that is to say on the opposite side of the rolling-body bearing 5 to the commutator 14. In this case, the external diameter of the centrifugal disk 16 is chosen such that there is an air gap between the circumferential surface of the centrifugal disk 16 and the inside of the receptacle 9. The air gap is preferably no larger than 0.5 to 3.0 mm, preferably 1.00 to 2.00 mm. In the present case, the centrifugal disk 16 has a corrugated profile 17, with the corrugations of the corrugated profile 17 being aligned coaxially with respect to the rotor shaft 3 and with respect to the rotation axis 18 of the rotor shaft 3, and each extending over the entire circumference of the centrifugal disk 16.

In this case, the corrugated profile 17 forms an incline 20 in the outer circumferential area 19 of the centrifugal disk 16, which incline 20 is aligned at an angle α which in the present case is about 40°, to the centrifugal disk 16, which is otherwise aligned essentially at right angles to the rotor shaft 3. In general, the angle may be 15° to 70°, in particular 25° to 60° in order to achieve the desired effect described in the following text:

As a result of the provision of the electrical machine 2 in the hydraulic unit 1, the electrical machine 2 is located in the immediate vicinity of a liquid 21 which, for example, is intended to be fed by means of the hydraulic unit 1. This liquid may gather in the area of the bearing, that is to say in the area of the rolling-body bearing 5, in the present case in the receptacle 9. During operation of the electrical machine 2, the liquid 21, which is moving in the direction of the rolling-body bearing 5, is thrown outward by the centrifugal disk 16 at the angle α, particularly when it reaches the rotor shaft 3. The incline preferably faces away from the rolling-body bearing 5 through the angle α, as a result of which liquid is thrown away from the rolling-body bearing 5. This ensures in a particularly simple manner that the liquid cannot enter the rolling-body bearing 5 and lubricant cannot be washed out of the internal area 13, which could lead to pasting of the commutator 14. This ensures in a simple manner that the electrical machine 2 and the hydraulic unit 1 have a long life. In this case, the centrifugal disk 16 expediently rests axially on the inner ring 10 of the rolling-body bearing 5. In this case, the centrifugal disk 16 preferably extends radially from the rotor shaft 3 to beyond the internal diameter of the outer ring 7. Because of the advantageous corrugated profile 17, a friction contact can be prevented between the outer ring 7 and the centrifugal disk 16.

In the exemplary embodiment shown in FIG. 1, an eccentric bearing 22 is also arranged on the rotor shaft 3 such that they rotate together, such that the centrifugal disk 16 is borne axially between the rolling-body bearing 5 and the eccentric bearing 22, preferably by being clamped in or borne in a braced manner.

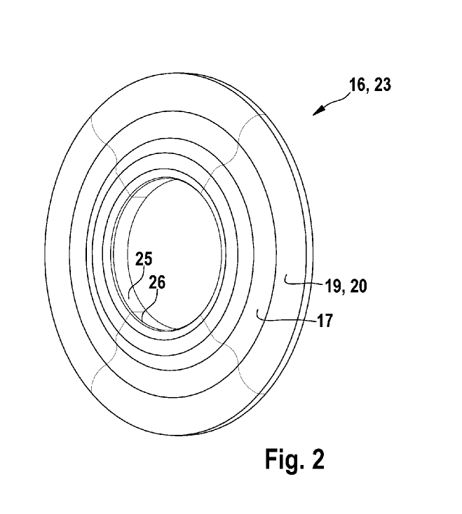

FIG. 2 shows a perspective illustration of the centrifugal disk 16 shown in FIG. 1. In the present case, the centrifugal disk 16 is in the form of a thermoformed or deep-drawn part 23. The incline 20 is in this case formed by the outer, bent circumferential area 19. Alternatively, the incline 20 may also be in the form of a projection of an otherwise planar centrifugal disk 16. The corrugated profile 17 forms a further incline 24 located radially further inward, which can likewise be used for centrifuging the liquid 21. On its rotor-shaft receptacle 25, the centrifugal disk 16 has a circular-cylindrical section 26, which ensures reliable alignment and arrangement of the centrifugal disk 16 of the rotor shaft 3. Advantageously, the centrifugal disk 16 is manufactured from a material which can be stamped, preferably from a C60 material, and preferably has a chemical nickel-phosphorous coating. The coating prevents the centrifugal disk 16 from becoming worn, and preferably increases its hardness such this corresponds to the hardness of the eccentric bearing 22.

Since the centrifugal disk 16 is arranged on that side of the rolling-body bearing 5 which faces away from the commutator 14, this effectively simply prevents the rolling-body bearing 5 from being washed out in the direction of the commutator 14, and therefore prevents pasting of the commutator 14.

1. An electrical machine (2) having at least one rotor shaft (3) which is borne by means of at least one rolling-body bearing (5) such that the shaft can rotate in a housing (4), with at least one commutator (14) being arranged on the rotor shaft (3) such that the commutator and the shaft rotate together, characterized in that a centrifugal disk (16) is arranged on the rotor shaft (3) such that the disk and the shaft rotate together, on an opposite side of the rolling-body bearing (3) to the commutator (14).

2. The electrical machine as claimed in claim 1, characterized in that a maximum diameter of the centrifugal disk (16) is at least as large as an internal diameter of an outer ring (7) of the rolling-body bearing (5).

3. The electrical machine as claimed in claim 1, characterized in that the centrifugal disk (16) has an incline (20) which extends over an entire circumference.

4. The electrical machine as claimed in claim 3, characterized in that the incline (20) is at an angle (α) of 15° to 70° to the centrifugal disk (16).

5. The electrical machine as claimed in claim 3, characterized in that a circumferential area (19) is bent in order to form the incline (20).

6. The electrical machine as claimed in claim 1, characterized in that the centrifugal disk (16) has an annular corrugated profile (17), at least in places.

7. The electrical machine as claimed in claim 1, characterized in that a maximum diameter of the centrifugal disk (16) is less than an internal diameter of the housing (4) in the area of the centrifugal disk (16).

8. The electrical machine as claimed in claim 1, characterized in that at least one eccentric bearing (22) is arranged on the rotor shaft (3), on a side of the rolling-body bearing (5) facing away from the commutator (14).

9. The electrical machine as claimed in claim 1, characterized in that the centrifugal disk (16) is held, axially between the eccentric bearing (22) and the rolling-body bearing (5).

10. A hydraulic unit (1), which has a housing (4) and an electrical machine (2) according to claim 1.

11. The electrical machine as claimed in claim 1, characterized in that the centrifugal disk (16) has an incline (20) which extends over an entire circumference and faces away from the rolling-body bearing (5), at least in an outer circumferential area (19).

12. The electrical machine as claimed in claim 3, characterized in that the incline (20) is at an angle (α) of 25° to 60° to the centrifugal disk (16).

13. The electrical machine as claimed in claim 1, characterized in that the centrifugal disk (16) is braced axially between the eccentric bearing (22) and the rolling-body bearing (5).
